(19) United States
(12) Patent Application Publication
(10) Pub. No.: US 2006/0092314 A1
(43) Pub. Date: May 4, 2006

(54) Autofocus using a filter with multiple apertures

(76) Inventors: D. Amnon Silverstein, Mountain View, CA (US); Henryk Birecki, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/979,013

(22) Filed: Oct. 31, 2004

(51) Int. Cl. H04N 5/335; H04N 5/232; G03B 3/00; G03B 13/18; G03B 13/32; H04N 3/14; H04N 9/04; H04N 9/083; G03B 13/00

(52) U.S. Cl. 348/349; 348/273

(57) ABSTRACT

A filter including multiple apertures for use in a camera's autofocus system is described. A variety of implementation examples of the filter are described. In one implementation, the filter includes an opaque portion which blocks light and apertures through which light travels. In another version, the apertures each include a color filter corresponding to a different color. In another example, the filter comprises a light blocking opaque portion with asymmetrically shaped apertures through which light travels. A defocus determination based on the filtered light is performed, and an adjustment to the distance between the optical system and an image sensing device is determined based on the determined defocus.

### BACKGROUND

### Field of Invention

The present invention generally relates to autofocus for cameras.

Shutter lag time is the time between a user's depression of a shutter button to take a picture and actual capture of an image, and it is one of the most critical performance specifications for satisfying camera users. The largest contributor to shutter lag time is autofocus which adjusts the distance between a lens and an image sensing device to achieve a sharper focus in the image area of interest. Several iterations of adjustment may be necessary based on a plurality of shots of the same image and convolution techniques in order to obtain an acceptable focus thus contributing to longer shutter lag time. An autofocus technique that can determine the degree of defocus based on one captured image and simpler calculations is highly desirable as it significantly reduces shutter lag time.

### SUMMARY OF INVENTION

The present invention provides one or more embodiment of a multiple aperture filter for use in an autofocus system. In one embodiment, the filter comprises an opaque portion which blocks light and clear multiple apertures through which light travels. In another embodiment, the filter comprises multiple apertures wherein each of the multiple apertures includes a different color filter for forming a corresponding color image on the image sensing device. In another embodiment of the present invention, the filter comprises a light blocking opaque portion and asymmetrically shaped apertures through which light travels.

An autofocus system in accordance with an embodiment of the present invention comprises a filter including multiple apertures optically aligned between an optical system and an image sensing device for forming multiple image representations of a same image on the image sensing device, a defocus determination module communicatively coupled to the image sensing device for determining defocus of the image based on the multiple image representations on the image sensing device, and an adjustment module for adjusting the distance between the optical system and the image sensing device based on determined defocus.

A method for determining defocus of an image in accordance with an embodiment of the present invention comprises generating multiple image representations of a same image on the image sensing device, determining defocus of the image based on the multiple image representations on the image sensing device, and adjusting the distance between an optical system and an image sensing device based on the determined defocus.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a functional block diagram of a camera including an autofocus system using a multiple aperture filter in accordance with an embodiment of the present invention.

FIG. 2 is a block diagram of an imaging system for use in an autofocus system including a multiple aperture filter for forming multiple image representations of the same image on an image sensing device that can be used in one or more embodiments of the present invention.

FIG. 3A illustrates a multiple aperture filter comprising an opaque portion which blocks light and multiple clear apertures through which light travels in accordance with an embodiment of the present invention.

FIG. 3B illustrates a multiple aperture filter comprising a light blocking opaque portion and asymmetrically shaped apertures through which light travels in accordance with yet another embodiment of the present invention.

FIG. 3C illustrates a multiple aperture filter comprising an opaque portion which blocks light and apertures, each including a different color filter in accordance with another embodiment of the present invention.

FIG. 3D illustrates another version of a multiple aperture filter comprising an opaque portion which blocks light and color filter apertures in accordance with yet another embodiment of the present invention.

FIG. 3E illustrates another version of a multiple aperture filter comprising an opaque portion which blocks light and color filter apertures in accordance with yet another embodiment of the present invention.

FIG. 3F illustrates a filter comprising a portion through which visible light travels and a ring portion including three color filter apertures in accordance with yet another embodiment of the present invention.

FIG. 4 illustrates a geometrical representation of filtered light generated by the filter in FIG. 3D upon which a cross-correlation algorithm for a defocus determination can be made in accordance with an embodiment of the present invention.

FIG. 5 illustrates a method for determining defocus for an image in accordance with another embodiment of the present invention.

The figures depict embodiments of the present invention for purposes of illustration only. One skilled in the art will readily recognize from the following discussion that other embodiments of the structures and methods illustrated herein may be employed without departing from the principles of the invention described herein.

### DETAILED DESCRIPTION OF THE DRAWINGS

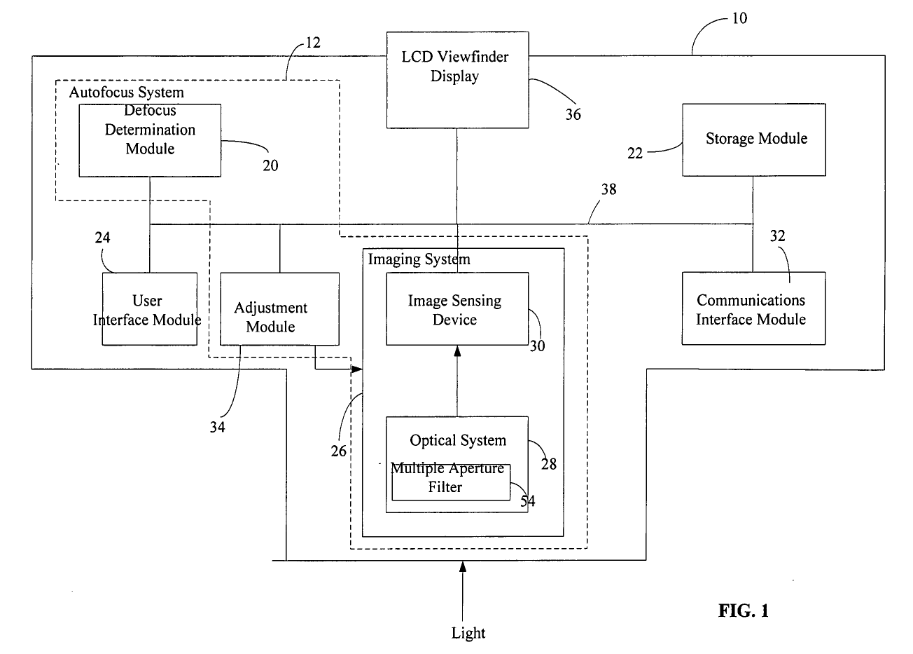

FIG. 1 is a functional block diagram of a camera 10 including an autofocus system 12 using a multiple aperture filter in accordance with an embodiment of the present invention. The camera 10, which can be a still image camera, a motion image camera (e.g., video) or a combination of the two, comprises an autofocus system 12 communicatively coupled via a communication bus 38 to a user interface module 24, a storage module 22 and a communications interface module 32. The autofocus system 12 comprises a defocus determination module 20 communicatively coupled via a communication bus 38 to an adjustment module 34 and an imaging system 26. The imaging system 26 includes an optical system 28 including a multiple aperture filter 54 which is optically coupled and aligned with an image sensing device 30. During autofocus, light received by the optical system 28 is filtered by the multiple aperture filter 54 resulting in multiple image representations of the same image on the image sensing device 30. The multiple aperture filter 54 effects the distribution of light on the image sensing device 30 that varies with defocus. The image sensing device 30 detects this distribution of light and represents it as computer readable data usable by the defocus determination module 20 in determining defocus. In one example, the image sensing device 30 can be embodied as a charge-coupled device (CCD) array of light sensitive elements which convert photons representing the intensity of received light to computer readable data.

The defocus determination module 20 determines an adjustment of the distance between the optical system 28 and the image sensing device 30 (hereafter also referred to as the “image distance” for ease of description) and communicates the adjustment to the image distance to the adjustment module 34. The adjustment module 34 is mechanically coupled to one or more of the elements within the imaging system 26 for moving one or more elements based on the distance adjustment from the determination module 20. In one example, the adjustment module 34 is embodied as a mechanical actuator that can move an element of the imaging system under the control of a stepper motor unit.

Objects within a scene being photographed have different subject distances to the optical system so that a focal point for a more distance object is not in the same plane as that for a closer object. Typically, the image sensing device 30 is divided into a plurality of blocks and a defocus determination is made for each block. The defocus determination module 20 can use the defocus determined for the different blocks to create a depth map for the image of the scene. The defocus determination module 20 determines the distance adjustment for a selected block, the block being selected based on criteria. One example of criteria is to use as a default the block receiving light from the subject in the focus area in the center of the LCD viewfinder display 36. In autofocus mode, the user interface 24 can display indicators for autofocus areas which a user can select to indicate another focus area as the basis for autofocus.

The defocus determination module 20 stores the determined defocus and adjustment for each block in the storage module 22. The storage module 22 stores data which can include software instructions as well as data for calculations and image data.

The user interface module 24 processes input from a user, for example, input indicated by pressing buttons on the camera and can also display information to the user on the display 36 which in this example is a liquid crystal display (LCD) which also acts as a viewfinder for displaying the scene. Additionally, the communications interface 32 provides an interface for external devices through which the camera can communicate data such as images.

Each of the modules illustrated in FIG. 1 or a portion thereof can be implemented in software suitable for execution on a processor and storage in a computer-usable medium, hardware, firmware or any combination of these. Computer-usable media include any configuration capable of storing programming, data, or other digital information. Examples of computer-usable media include various memory embodiments such as random access memory and read only memory, which can be fixed in a variety of forms, some examples of which are a hard disk, a disk, flash memory, or a memory stick.

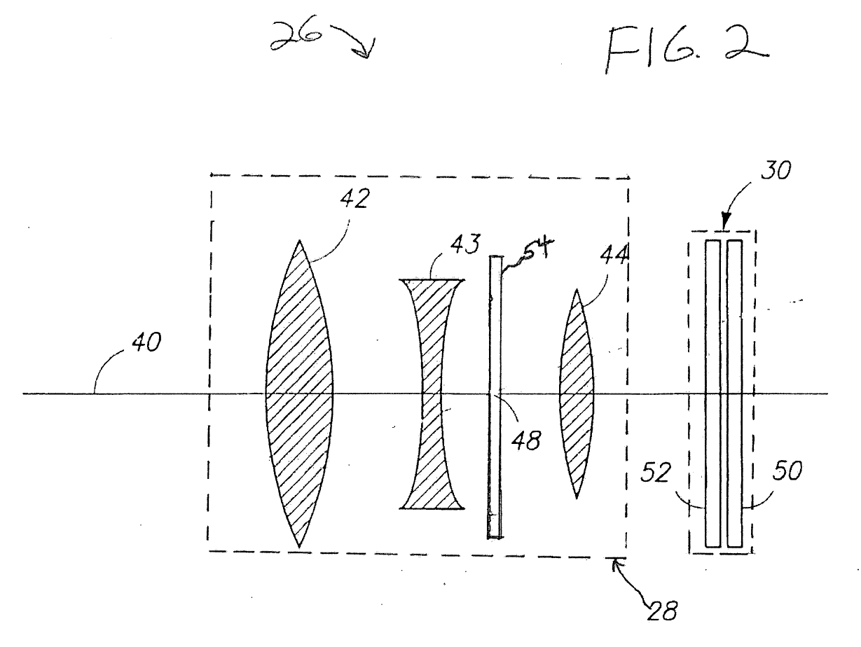

FIG. 2 is a block diagram of an imaging system 26 including an optical system 28 with a multiple aperture filter 54 and an image sensing device 30 for use in an autofocus system that can be used in one or more embodiments of the present invention. The optical system 28 is arranged as a triplet lens system about an optical axis 40 for directing light to the image sensing device 30. The triplet lens system includes a biconvex front lens 42, a biconcave middle lens 43, and a biconvex back lens 44 aligned to optical axis 40. An embodiment of a multiple aperture filter 54 is located at an aperture stop 48 located in alignment with the optical axis 40.

In this embodiment, the image sensing device 30 is embodied as a charge-coupled device (CCD) comprising an array of light sensitive elements 50 optically coupled with a filter 52 configured to provide a red, green, blue (RGB) mosaic pattern in which individual light sensing elements, corresponding to individual pixels in a digital representation, are particularly sensitive to red, green, or blue as defined by the filter. In another embodiment of the image sensing device 30, the light sensing elements of the CCD array each respond to an individual color (e.g., a CCD created using Foveon technology) so that the filter 52 is unnecessary.

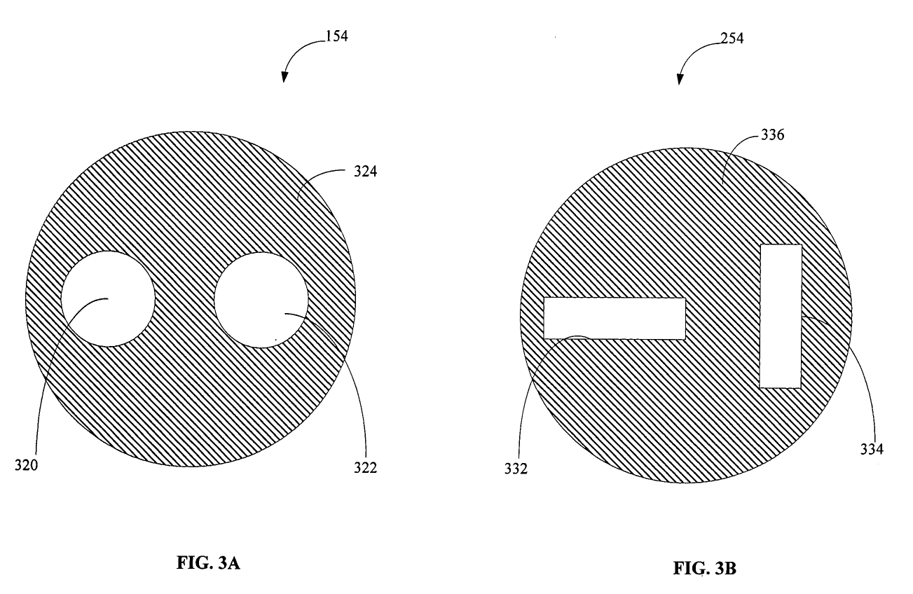

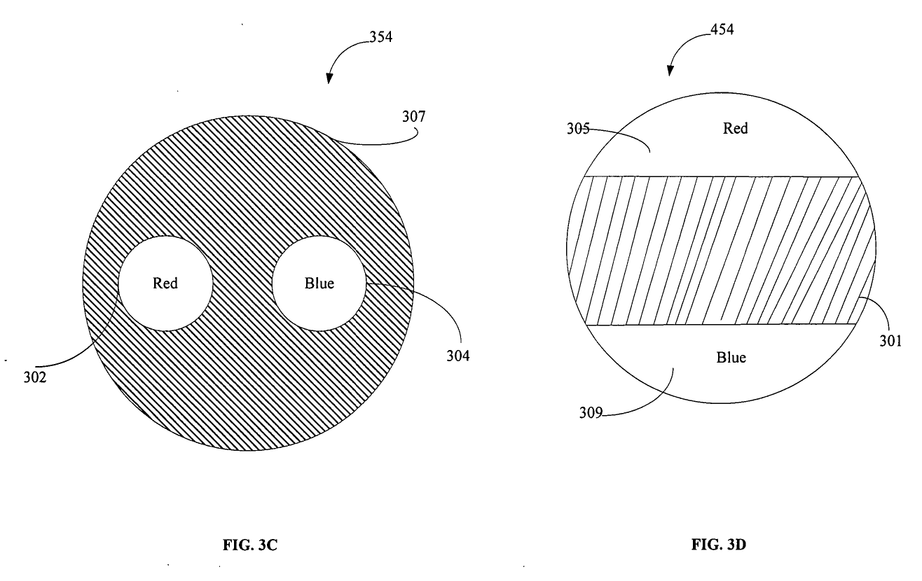

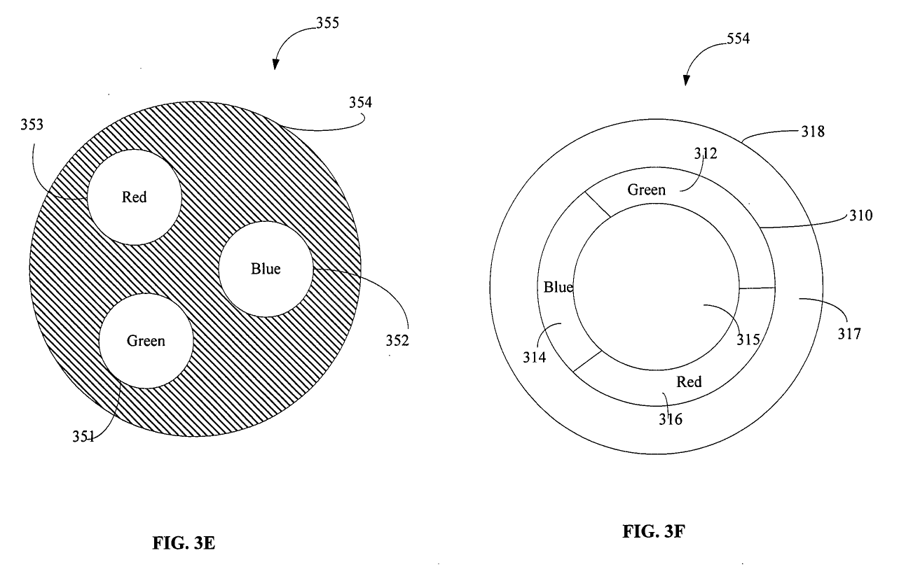

FIG. 3A illustrates a multiple aperture filter 154 comprising an opaque portion 324 which blocks light and multiple clear apertures 320, 322 through which light travels in accordance with an embodiment of the present invention. In this example, if the scene is defocused, two overlapping images will be formed on the image sensing device 30. The resulting double image is approximately the same as the result of convolving a single well focused image with a blur kernel that has the same shape as the aperture filter 154, and which has been scaled by an amount that is proportional to the amount of defocus. If the blur kernel can be estimated, the degree and magnitude of defocus can be approximately determined. One well-known method for recovering an unknown blur kernel is “blind deconvolution”. After the blur kernel is recovered, it is compared in size to the aperture filter 154. The ratio of the size of the blur kernel to the size of the filter 154 will be proportional to the distance of the focal plane to the image sensing device 30 relative to the distance between the image sensing device 30 and the filter 154.

If the filter 154 consists of two small apertures 154, the blur kernel will be approximately the same as two points separated by a distance that is proportional to the degree of defocus. In this case autocorrelation can be used to determine the distance between the two points. When the image is auto correlated along the axis of the two apertures, the autocorrelation function will have three sharp peaks. The distance between the first and the center peak will be equal to the distance between the two points in the kernel, and this distance will be proportional to the degree of defocus.

FIG. 3B illustrates a multiple aperture filter 254 comprising a light blocking opaque portion 336 and asymmetrically shaped apertures 332, 334 through which light travels in accordance with yet another embodiment of the present invention. Identical clear openings as illustrated in the embodiment of FIG. 3A do not provide information on the direction of defocus, for example, whether the image is inside or outside of focus. One way to resolve this ambiguity is to use asymmetrically shaped apertures so that the defocus determination based on either deconvolution or auto-correlation can provide both an amount and direction of defocus. Both deconvolution and auto-correlation require complex mathematical computations related to convolution which adds to the autofocus time and, hence, the shutter lag time.

FIG. 3C illustrates a multiple aperture filter 354 comprising an opaque portion 307 which blocks light and apertures 302, 304, each including a different color filter in accordance with another embodiment of the present invention. By using colored apertures such as a red aperture 302 and a blue aperture 304, much simpler cross-correlation techniques can be used instead of more complicated convolution based techniques. The use of different color filters in combination with light sensitive elements sensitive to the different colors provides easier detection of the boundaries of the two images. From the detection of the boundaries, corresponding blocks can be determined between the two images so the defocus, including amount and direction, can be determined for an object of interest within a selected block or for a block wise depth map of the scene.

FIG. 3D illustrates another version of a multiple aperture filter 454 comprising an opaque portion 301 which blocks light and color filter apertures 305, 309 in accordance with yet another embodiment of the present invention. The red aperture 305 forms the top side of the filter 454, and the blue aperture 309 forms the bottom side of the filter with both sides being separated by the middle opaque portion 301.

For an example illustrating cross-correlation, consider a scene in which a person in the foreground is being photographed against a background of a tall tree fifty feet behind the person. The focal point for the top of the person's head falls behind the plane of the image sensing device 30, and the focal point for the top of the tall tree falls in front of the image sensing device's 30 plane. In this example, the autofocus system includes a CCD array 30 having an RGB mosaic and a multiple aperture filter 354 or 454 is aligned to receive the light from the image. In comparison of the color sensitive intensity data from the red image block and the blue image block including the tree top, the defocus determination module 20 detects that the tree top in the red image block extends the equivalent of about a two-pixel width to the right of the tree top in the blue image block. Similarly, the defocus determination module 20 detects that the top of the person's head in the red image block extends the equivalent of about one pixel width to the left of the top of the head in the blue image block. Both horizontal and vertical separation of the two images can be detected. Thus, the contrasting color intensity measured by the color sensitive elements of the CCD device 30 make determination of direction and amount of defocus easier to determine than using convolution based techniques.

By using a filter such as the embodiments illustrated in FIGS. 3C and 3D, the data for the doubled image can be processed by the defocus determination module 20 to shift misaligned colored image areas as represented by individual pixel values into better alignment for a sharper focus.

FIG. 3E illustrates another version of a multiple aperture filter 355 comprising an opaque portion 354 which blocks light and three color filter apertures, a red one 353, a blue one 352 and a green one 351 in accordance with yet another embodiment of the present invention. In this embodiment, three images are formed on the image sensing device 30, and three cross-correlations are performed, one for each set of filters, (e.g., red and green, blue and green and red and blue) thus providing more comprehensive data and greater accuracy in the defocus determination.

For each of the filters (e.g., 354, 454, 355) with color apertures, the aperture size can vary based on considerations. For example, bigger apertures will result in more light so that the multiple aperture filter does not need to be removed out of the autofocus mode cutting down on motor wear and battery life; however, overlap is possible, particularly between a green and blue filter, thus cutting color contrast and making defocus determination more difficult.

FIG. 3F illustrates a filter 554 comprising a portion 315 through which visible light travels and a ring portion 310 including three color filter apertures, one for filtering red light 316, one for filtering green light 312 and one for filtering blue light 314 in accordance with yet another embodiment of the present invention. In this example, the apertures are of equal size, arcs of 120 degrees, making up the ring. By using a three color mask filter 554, the color balance of the picture can be unaffected. The ring layout 310 focuses mainly on the peripheral rays which contribute most to the autofocus signal detected with the filter 554. Light for the image is received without blocking in the clear inner portion 315 and the clear outer portion 317. The three color ring filter 554 also provides the advantage that the focus signal is potentially less sensitive to the color content of the photographed scene. The diameter of the ring can be optimized within the maximum lens aperture 318 to maximize the focus signal with minimum overall light loss. Additionally, thicknesses in different areas can be varied if necessary so as not to introduce lens aberrations. Also, as spherical aberration is a fixed property of the lens, it can be corrected for in digital signaling processing.

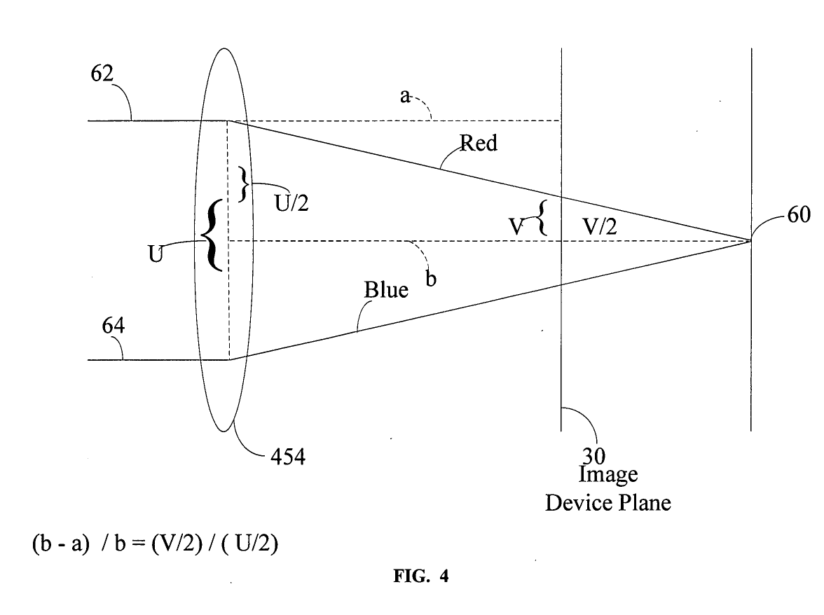

FIG. 4 illustrates a geometrical representation of filtered light generated by the filter 454 in FIG. 3D upon which a cross-correlation algorithm for a defocus determination can be made in accordance with an embodiment of the present invention. The geometrical representation used for cross-correlation is a triangle. The discussion is in terms of light rays for ease of description. Light ray 62 passes through the red colored filtered aperture 302 thus resulting in a corresponding red ray intersecting the image sensing device 30 at the image plane. Light ray 64 passes through the blue colored filtered aperture 304 thus resulting in a corresponding blue ray intersecting the image sensing device 30 at the image plane. The distance U between the points of intersection of the light rays 62 and 64 with the filter 454 is known. From measurements of the color sensitive elements, the image device 30 detects its intersection with the red ray and the blue ray. As the pixel width is known between the color sensitive elements of the image device 30, the distance V between the intersection points of the red ray and the blue ray can be determined. Also from the intersection points of rays 62 and 64 with the filter 454 and the intersection points of the red ray and the blue ray with the image sensing device 30, the location of the desired focal point 60 is determined. The letter b represents the distance from the filter 454 to the focal point 60. Similar triangles are formed from which the adjustment (b-a) in the distance from the optical system 28 to the image sensing device 30 can be determined. A first similar triangle, in this case a right triangle, is formed of the sides represented by U/2, b, and the red ray. The second similar triangle, also a right triangle in this case is formed by the sides V/2, (b-a), and a portion of the red ray as a hypotenuse. Similar triangles share the same angles. The second similar triangle is a proportional version of the first. Thus, (b-a) is proportional to b as V/2 is proportional to U/2. Thus, (b-a) is equal to ((V/2)/(U/2)) b.

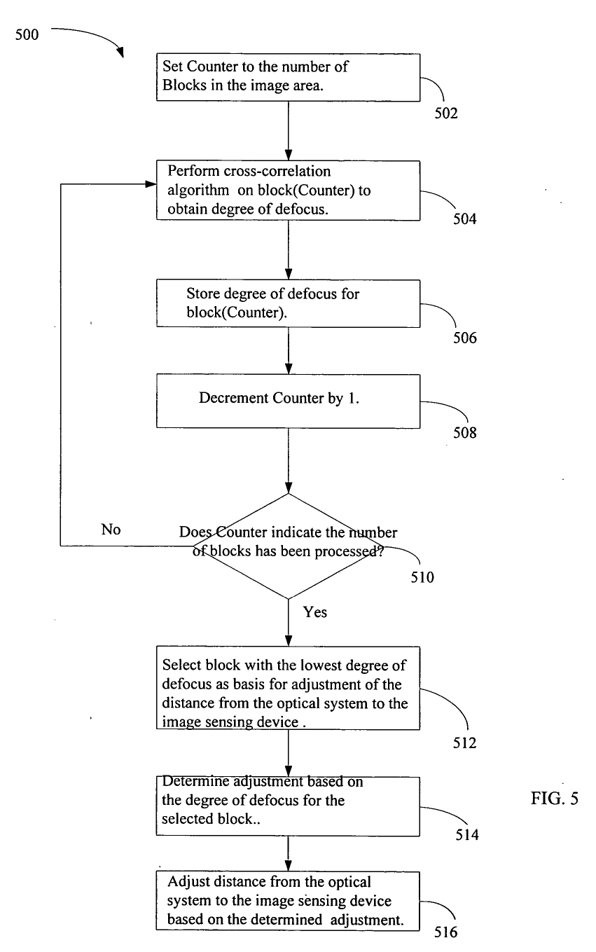

FIG. 5 illustrates a method for autofocus in an image capture device using a filter including multiple apertures in accordance with an embodiment of the present invention. For illustrative purposes only and not to be limiting thereof, the method embodiment 500 of FIG. 5 is discussed in the context of the system embodiment 100 of FIG. 1. The defocus determination module 20 sets 502 a counter variable to the number of blocks in the image area, and performs 504 a cross-correlation algorithm on a current block being processes represented by block(Counter) to obtain a degree of defocus for the block, and stores 506 the degree of defocus for block(Counter) in the storage module 22. The defocus determination module then decrements 608 the counter by 1 and determines 510 whether the number of blocks has been processed. Responsive to some blocks remaining to be processed, the defocus determination module 20 performs 504 the cross-correlation algorithm for the next block, block(Counter) to determine its degree of defocus which is also stored 506 in the storage module 22. Again, the counter is decremented 508 and the defocus module 20 determines 510 whether another block is to be processed. Responsive to determining 510 that there are no more blocks to process, the defocus module 20 selects 512 the block with the defocus, and determines 514 the adjustment to the distance between the optical system 28 and the image sensing device 30, the image distance, based on the degree of defocus. The defocus module 20 may select another block as the basis of adjustment responsive to user input or based on other considerations. An example of other considerations would be causing the defocus of another block to be degraded outside of parameters. The defocus module 20 communicates the determined adjustment to the adjustment module 34 which adjusts 616 the distance between the optical system 28 and the image sensing device 30 based on the determined adjustment.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the hereto appended claims. As will be understood by those familiar with the art, the present invention may be embodied in other specific forms without departing from the spirit or essential characteristics thereof.

1. An auto-focus system comprising:
an image sensing device including light sensitive elements for providing computer readable data from the light sensitive elements;
an optical system optically aligned with the image sensing device and separated from the image sensing device by an image distance;
a filter including multiple apertures optically aligned with the optical system and the image sensing device for forming multiple images of a same image on the image sensing device;
a defocus determination module communicatively coupled to the image sensing device for determining defocus of an image based on the computer readable data from the light sensitive elements and determining an image distance adjustment; and
an adjustment module for adjusting the image distance between the optical system and the image sensing device based on the image distance adjustment.

2. The system of claim 1 wherein the defocus determination module performs deconvolution on the computer readable data for determining the defocus of the image.

3. The system of claim 1 wherein the defocus determination module performs auto-correlation on the computer readable data for determining the defocus of the image.

4. The system of claim 1 wherein each of the multiple apertures includes a color filter for a different color for forming an image on the image sensing device for that color.

5. The system of claim 4 wherein the defocus determination module performs cross-correlation on computer readable data for the images formed for each different color.

6. The system of claim 4 wherein each different color filter matches a color sensitivity of color sensitive elements on the image sensing device.

7. The system of claim 4 wherein the filter comprises two color filters.

8. The system of claim 7 wherein the two color filters are a red filter and a blue filter.

9. The system of claim 7 wherein the two color filters are a red filter and a green filter.

10. The system of claim 7 wherein the two color filters are a blue filter and a green filter.

11. The system of claim 4 wherein the filter comprises three color filters.

12. The system of claim 11 wherein the three color filters are a red filter, a blue filter and a green filter.

13. The system of claim 4 wherein the filter is clear in area outside the color filters.

14. The system of claim 4 wherein the filter remains in aligned with the optical system and the image sensing device during image capture after autofocus has been completed.

15. A filter for use in an auto-focus system of a camera, the filter comprising multiple apertures optically aligned with an optical system and an image sensing device in the camera for forming multiple images of a same image on the image sensing device.

16. The filter of claim 15 wherein each of the multiple apertures includes a color filter for a different color for forming an image on the image sensing device for that color, each different color filter matching a color sensitivity of color sensitive elements on the image sensing device.

17. A method for autofocus comprising:
generating multiple image representations of a same image on an image sensing device;
determining defocus for the image based on data for the multiple representations;
determining an adjustment amount to an image distance between an optical system optically aligned with the image sensing device; and
adjusting the image distance based on the determined adjustment.

18. The method of claim 17 wherein the multiple image representations correspond to color filtered representations of the same image in different colors and determining defocus for the image further comprises performing cross-correlation between each set of different colored filtered representations.

19. A computer usable medium comprising instructions for causing a processor to execute a method for autofocus, the method comprising:
generating multiple image representations of a same image on an image sensing device;
determining defocus for the image based on data for the multiple representations;
determining an adjustment amount to an image distance between an optical system optically aligned with the image sensing device; and
adjusting the image distance based on the determined adjustment.

20. The computer usable medium of claim 19 wherein the multiple image representations correspond to color filtered representations of the same image in different colors and the method further comprises determining defocus for the image further comprises performing cross-correlation between each set of different colored filtered representations.
